(19) United States
(12) Patent Application Publication
(10) Pub. No.: US 2007/0110208 A1
(43) Pub. Date: May 17, 2007

(54) Antimatter electrical generator

(76) Inventor: Alberto Molina-Martinez, Manassas, VA (US)

Correspondence Address: Alberto Molina-Martinez, 7805 Flager Circle, Manassas, VA, 20109, US

(21) Appl. No.: 11/280,636

(22) Filed: Nov. 17, 2005

(51) Int. Cl. H05H 1/22

(52) U.S. Cl. 376/100

(57) ABSTRACT

The present set of complementary inventions refer to a system for the practical and inexpensive procurement of huge amounts of energy derived from the principles of matter-antimatter generation and annihilation. The generator will comprise the functions of generation, amplification, concentration and collision of photons within a specially designed self-reflective chamber; the generation of particles of matter and antimatter derived from the collision of photons; the ionization of atoms and the production of avalanches of electrons and positrons within a specialized collecting chamber; the separation of electrons and positrons by the action of powerful rotational electromagnetic fields; and, the conversion of said avalanches of electrons and positrons into electrical power. A second embodiment will separate particles of matter and antimatter generated in a similar way into antimatter fuel by the action of rotational monopolar electromagnetic fields.

### RELATED PATENT APPLICATION

This application claims priority to U.S. Provisional Patent Application No. 60/626,546 entitled “Antimatter Electrical Generator”, filed Nov. 10, 2004, and identifying Alberto Molina-Martinez as the inventor. The subject matter of U.S. Provisional Patent Application No. 60/626,546 is hereby incorporated by reference in this application.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates to the field of electricity generation, and more particularly to electric power extracted from the collision and annihilation of matter and antimatter particles.

2. Background of the Invention

Contrary to the massive amounts of energy and extremely costly installations needed today for the acceleration and collision of subatomic particles at near the speed of light, which has kept antimatter as an utopian source of energy, the present invention encompasses in itself the generation, amplification, concentration and collision of photons for the production of matter and antimatter particles and the direct conversion of their energy into electric power and/or antimatter fuel, in a practical and inexpensive way.

Particle Physics

As Physicists penetrate more and more deeply into the constitution of matter, the more we have learned about the subatomic particles, forces and forms of energy of which matter and the universe are made of. Some of these particles are considered elemental particles since they have not constituents but themselves, as electrons, up quarks and down quarks. The rest of parts of the atom are made of a combination of these three elemental particles. Some others have been found or produced artificially but are unstable and are not found in nature. In the same way some forces that keep particles, atoms and molecules together have been identified and named as: Electromagnetism (which keeps particles of different charge together, and apart the ones of similar charge); Residual Electromagnetic Force (which keep atoms together); Strong Force (which keep quarks together); Residual Strong Interaction (which keeps the nucleus together); Weak Force (which holds together unstable massive quarks and leptons), etc. The Photon has been found to be the carrier particle of Electromagnetic Force, while the Gluon is the carrier particle of Strong Force, and the carrier particles of Weak interactions are called W+, W− and Z, being the W's electrically charged, and Z, neutral.

Decay, Antimatter & Annihilation.

Some unstable elements may decay into other elements, liberating energetic particles in a phenomenon known as radiation. Scientists have identified three types of radiation which are called Alpha (composed of Helium nuclei), Beta (which are high speed electrons) and Gamma radiation (which is made of high energy photons). Elemental particles may decay but into a less massive particle and a force-carrier particle.

Also it has been found that every particle that exists has its own anti-particle or anti-matter, which is exactly equal but opposite. Scientists ignore where the antimatter went, since it has not been found in the universe. When a matter particle encounters its antimatter particle they both completely annihilate into a very energetic force carrier particle (Gluon, W/Z or Photon). These force carriers then transform into other particles. The antimatter phenomena has long been considered as the ultimate source of energy, but a practical or efficient way to seize it has not been yet discovered, until now.

Particle Accelerators

Physicists use enormous particle accelerators to produce high energy particles collisions in order to study the composition of matter. There are two types of accelerators, linear accelerators which are called Linac, and circular or semicircular accelerators named Synchrotron. Synchrotrons must have a perimeter of many kilometers in order to accelerate particles near the speed of light before the collisions. The Large Hadron Collider, under construction in Europe in an international collaboration, will have a perimeter of twenty seven kilometers. Modem accelerators consist basically of: a Particle Generator; a Linac, which provides the initial linear acceleration to the particles; the Synchrotron for the grand acceleration, and the Detectors, where the collisions take place and which trace the events and register data for subsequent study and analysis.

The Synchrotron, the main accelerator, consists of a vacuum chamber, which is a metal pipe where air is permanently pumped out, that goes all along the accelerator and where the particles are accelerated to near the speed of light; vacuum pumps; dipole and quadrupole magnets, which will give the particles direction and focus, respectively; radio-frequency cavities, which will accelerate the particles by transferring energy to them from powerful radio-waves amplifiers; high voltage instruments and electronic circuits, etc.

Detectors typically consist of several layers of different detecting areas surrounding the vacuum chamber: first comes the Tracking Chamber, which will show the path of some particles as electrons, positrons, muons, protons, etc, but not others as photons or neutrons, indicating their charge and momentum; second, the Electromagnetic Calorimeter, which will detect and measure the energy of light particles as electrons and photons as they interact with the electrically charged particles inside matter; third, the Hadronic Calorimeter which measure the energy of hadrons, particles containing quarks, like protons and neutrons, as they interact with the atomic nuclei; fourth, the Muon Detector, which can be gas-filled chambers that will detect the passage of Muon charged particles that normally travel long distances and pass all the way through the detector leaving only a signal on this detector.

Calorimeters may consist of layers of absorbing high density material as lead or steel, which slow down charged particles, interleaved with layers of an active medium such as solid lead-glass or liquid argon.

Special type of detectors are the Multiwire Proportional Chambers, which consist essentially of a set of thin, parallel and equally spaced anode wires, walled in between two cathode planes, in a gaseous atmosphere. When a negative potential of some level is applied to the cathodes, the anodes being grounded, an electric field develops as to attract electrons liberated by ionizing events as the crossing of charged particles. An avalanche multiplication of free electrons will then occur, amplifying the signal, which can then be measured.

Multiwire Proportional Chambers, for which the 1992 Nobel Price in Physics was awarded to Georges Charpak of CERN (European Laboratory for Particle Physics) had permitted among many other discoveries, the elucidation of the behavior and the effect of charged particles crossing masses of atoms at rest, which causes the ionization of said atoms and the generation of electron-ion pairs, this is an electron and a positron, matter and antimatter of each other. The electron pair will continue to drift, creating more electron pairs and so on, forming, under the proper circumstances, what is known as an avalanche multiplication in proportional counters.

Efficiency

The particles used for the collisions are relatively easy and cheap to produce. Electrons are produced by heating metals; Protons can be easily obtained by ionizing hydrogen; Antiparticles can be obtained by making energetic particles hit a metal target, in a process where first, carrier particles as Photons or Gluons are created and then transformed into pairs of particles and antiparticles, which in turn are separated by the use of magnetic fields. Photons are easy and cheap to produce by the trillions just by the stimulation of atoms of many materials with electric discharges or light flashes.

However, the amount of energy needed to store and then accelerate particles for the collisions is, by very far, greater than the energy obtained from the collision of the particles, making the process extremely inefficient in energy terms. In the same way, the cost of building a Synchrotron is in the order of billions of dollars. Obviously those installations are designed for research purposes, not for energy production.

Particles Collisions

When an electron and a positron (the anti-electron) collide at high energy, they annihilate releasing a tremendous amount of energy (accordingly to E=mc²) in the form of a Photon or a Z particle, which then converts into a D+ meson (a particle made of a charm quark and an anti-down quark) and a D⁻ meson (a particle made of an anti-charm quark and a down quark).

In the same way, a quark from within a proton and an anti-quark from an anti-proton colliding at high energy will release a great amount of energy (accordingly to E=mc²) in the form of a Gluon, from which a top-quark and a top-antiquark emerge, which then decay into other particles.

Similarly, when two Photons collide they form a charm quark and an anti-charm quark, which in turn convert into a C-Jet (a beam) of particles and a C⁻-Jet of antiparticles of the first, releasing a formidable amount of energy, in the order of 183 to 209 GeV per collision, as consistently has been observed and recorded by scientists with the ALEPH detector at the Large Electron-Positron Collider at CERN.

Light and Photons

Photons, or electromagnetic particles, are considered packages of pure energy traveling at the speed of light, 299,792,458 meters per second in vacuum, which behave also as electromagnetic waves. The wavelength and the wave frequency is what determines the type of electromagnetic wave. Radio waves, Microwaves, Visible Light, X-Rays and Gamma Rays are all electromagnetic waves or photons. Visible light from violet to red light is just one thousand of the electromagnetic spectrum. The amount of energy of an electromagnetic wave depends on the wavelength and the frequency. Thus, gamma rays have the most energy, and radio waves have the least.

The energy of a single photon is given, in terms of its frequency, f, or wavelength, γ, as,
Wph=hf=hc/γ
were h is Plank's constant,
h=663×10−36 Joules
and c, the speed of light in free space,
299,792,458 m/s
The conversion factor from electron-volts to Joules is given by,
1 eV=160×10−21 Joules

According to these formulas visible photons range in energy from 1.74 eV (700 nanometers) to 3.34 eV (400nanometers). The energy of a photon with a wavelength of 10,600 nm from a CO₂ powerful laser would be in the order of 36.57 eV. The amount of energy needed to generate two photons would be twice these amounts, plus the inherent losses of the process. A 100 watts light bulb, or a CO2 laser will generate hundreds of trillions of photons per second by means of the stimulation of their filament and molecules, respectively.

How come then, a collision of two photons can yield an amount of energy in the order of 183 to 209 GeV (Giga-electron Volts) as measured with the ALEPH detector at CERN? These amounts of energy are easily billions of times the sum of two Photon's energy, as calculated before.

The apparent reason is that the quoted formulas, only refer to the kinetic energy of the photons, not its constitutional energy, in the same way that the kinetic energy in 1 Kg. of sugar falling from an altitude of 10 meters, has nothing to do with its constitutional energy given by E=mc². Just to remember, the lack of mass of photons do not allow us to calculate their energy with Einstein's formula.

Laser Technology

Photons can be produced and directed as a beam using laser technology, or can be recovered from natural light or other sources, concentrated and redirected by the use of mirrors or lenses to form a beam of photons as dense as desired. Photon beams from lasers are monochromatic, coherent and very directional, while natural light photons are disperse, non-coherent and polychromatic.

To obtain photons from a laser system, a particular medium is “pumped” or stimulated, normally by flashes of light or by electrical discharges, to get the atoms into an excited state. Electrons from this excited atoms will jump to higher but unstable orbits. When this atoms relax, the electrons return to their normal orbit, but in the process they release energy in the form of photons. Photons, traveling at the speed of light, will stimulate new atoms, which will liberate more and more photons. The photons emitted in this way have a very specific wavelength that depends on the state of the electron's energy when the photon is released. Two of the same atoms in identical state will release photons with identical wavelengths. A system of parallel mirrors, one of them partially silvered coated, will align the photons to produce a photon beam through the partially coated mirror.

There are many types of lasers depending on the medium utilized. The Laser medium can be a solid, gas liquid, a plasma or a semiconductor. Some laser types and their wavelengths are the following:

| | | |
|---|---|---|
| Argon Fluoride | 193 | nm (nanometers) |
| Krypton Fluoride | 248 | nm |
| Nitrogen | 337 | nm |
| Argon (blue) | 488 | nm |
| Argon (green) | 514 | nm |
| Helium neon (green) | 543 | nm |
| Helium neon (red) | 633 | nm |
| Ruby | 694 | nm |
| Nd:Yag (NIR) | 1064 | nm |
| Carbon Dioxide | 10600 | nm |

Some of this lasers are inoffensive to humans but others are dangerous as the CO2 because its wavelength is in the infrared and microwave part of the spectrum. Infrared radiation is heat and this laser can melt through whatever it is focused on.

Industrial and medical beams can be composed of electrons, positrons, neutrons, protons, hadrons, ions, X Rays, microwaves, etc. which could eventually be used as source of particles for collisions under the present invention, having in mind that their production may be far more expensive and elaborated than photon's production.

Fiber Optic Cable, a thin glass fiber cable (or a special type of plastic fiber) of just microns in diameter, can be used to transmit photons in a wide range of wavelength and frequencies. The light source can either be a light emitting diode (LED), a laser or common light properly directed. Light moves easily down the fiber-optic line because of principle known as total internal reflection, which states that when the angle of incidence exceeds a critical value, light can not get out of the glass; instead the light bounces back in. The speed of light will be affected by the medium through which it has to travel, being vacuum the best medium. The glass in the fiber-optic may reduce the speed of light to some extent, but in short distances may not be meaningful.

Electromagnetism, Electricity, and a new Theory of Electricity

Its well known that electromagnetism and electricity are interrelated phenomena, but yet our theories about how electricity forms from magnetism lack some explanations. It is believed that electricity consists of the flow of electrons traveling from the negative pole to the positive pole, phenomena some how created by the crossing of a magnetic field through a conductor. Still, there are too many unanswered questions in this theory. From what atoms or what particular matter would those electrons come from; what will be the condition of the matter that released its electrons by the trillions; in virtue of what would those electrons travel to the positive pole, to accommodate where?

Energy originates matter, and matter can transform back into energy, as we have been able to establish by scientific verification. But electrical energy has two different manifestations, equivalent but opposed, antithesis of each other, the positive and the negative.

Electricity must be the flow of both, the positive constituent and the negative constituent, created or dissociated from matter by the action of a moving magnetic field. What could be happening, is that the crossing of a magnetic field through a conductor, would create Electron Pairs, an electron (with a negative charge) and a positron (with a positive charge), which will flow in opposite directions by the action of the magnetic field movement, according to the well known rule of thumb.

It has been proven in Multiwire Proportional Chambers, that negatively charged electrons travel at much higher speeds than positrons, probably a thousand times faster, which may be the reason why we thought that only negative electrons travel in an electric circuit.

We could assert that: Electricity is the flow of both, the negative element and the positive element, the electron and the positron, in opposite directions along a conductor, induced by the crossing of a magnetic field through the conductor, in which, at the closing of the circuit, both will flow to the mutual encounter by the attraction of opposites, nullifying each other, annihilating each other, since each one is the antimatter of each other.

As electrons and positrons flow along the conductors we have the opportunity to use the phenomena in different ways, as electromagnetic force, heat, light, etc.

### SUMMARY OF THE INVENTION

The present invention refers to a system for the practical and inexpensive procurement of huge amounts of energy derived from the principles of matter-antimatter generation and annihilation.

The Generator comprises several functions simultaneously: Generates photons at an exponentially increasing rate by the continuous excitement and stimulation of atoms; produces a continuously increasing concentration of photons traveling at the speed of light within a confined environment; induces forced collisions of photons at the speed of light at continuously increasing rates; generates Jets of particles and antiparticles of matter/antimatter by the collision of photons; converts particles and antiparticles' energy directly into electricity. A second embodiment will convert particles and antiparticles into antimatter fuel for propulsion purposes.

The core of the system is a micro-reactor that generates photons within a specially designed Self-Reflective Chamber that will not allow photons to escape and continuously increases their amount and concentration by the continuous amplification of said photons at increasing rates. Photons trying to escape the Chamber will be reflected back to the chamber continuously and indefinitely, at the speed of light.

Hundreds of trillions of photons traveling at the speed of light will be crossing paths with other photons in a high and continuously increasing Photon Density environment, for which it is to anticipate that myriads of collisions could be taking place simultaneously. Each of these collisions will produce Jets of particles and antiparticles, which, this time, will pass across the walls of the Self-Reflective Chamber creating a continuous flow of particles and antiparticles toward the exterior of the Chamber.

Myriads of Jets of electrically charged particles and antiparticles passing across the masses of specialized Collecting Chambers simultaneously will generate ion-pairs dissociation, this is electrons and antielectrons or positrons, which in turn will generate myriads of avalanches of the same electrons and positrons. Electrons and positrons are then separated by the action of powerful Electromagnetic Rotational Fields, generating very high electric potentials or power across the terminals of the Collecting Chambers.

A second embodiment will, instead, separate the Jets of particles and antiparticles by charge, positive or negative, without any interference with matter, by the use of powerful Monopolar Electromagnetic Rotational Fields. Particles and antiparticles thus created and separated can be used as propellant fuel for rockets or combustion engines. Antimatter fuel could then be produced in site, on demand, in practically any amount.

In essence, the Antimatter Electrical Generator converts almost ordinary matter into pure energy.

### DESCRIPTION OF DRAWINGS

FIG. 1 Shows a Self-Reflective Chamber aimed for the production of photons and photon's collisions.

FIG. 2 Front view of the Antimatter Electrical Generator, showing the basic elements of which it is made.

FIG. 3 Lateral dissection of the Antimatter Electrical Generator.

FIG. 4 Antimatter Electrical Generator insulated Collecting Mass frontal dissection.

FIG. 5 Electrical interconnections of the Antimatter Electrical Generator's rotational electromagnetic field system, in a typical three phase arrangement.

FIG. 6 The Electromagnetic Field Pattern created when a three phase alternating currents voltage is applied to coils spaced 120° spatial and electrical degrees, at a given instant.

FIG. 7 Rotational Electromagnetic Field created when a three phase alternating currents voltage is applied to coils spaced 120 spatial and electrical degrees, in one cycle.

FIG. 8 Hypothetical collision of photons inside the Self-Reflective Chamber, and the dispersion of charged particles and antiparticles into the core and the Collecting Masses.

FIG. 9 Front view of the embodiment of an Antimatter Fuel Generator aimed to the production of antimatter fuel for propulsion systems, showing also the electrical interconnections for the generation of a Monopolar Rotational Magnetic Field.

FIG. 10 Three Phase Direct Current System power pattern curves, for the creation of a monopolar rotational electromagnetic field.

FIG. 11 Electromagnetic field pattern created by the application of Three Phase Direct Current Voltages to the Antimatter Fuel Generator, at a given instant.

FIG. 12 Rotational Monopolar Electromagnetic Field created when Three Phase Direct Current Voltages are applied to coils spaced 120 spatial and electrical degrees, in one cycle.

FIG. 13 Lateral dissection of the Antimatter Fuel Generator where particles and antiparticles are separated and deviated towards opposite ends of the generator.

FIG. 14 A second embodiment of the Antimatter Fuel Generator where the Cooling Chamber has been removed.

### DETAILED DESCRIPTION OF THE INVENTIONS

Part A—Electrical Systems

Principles for the Antimatter Electrical Generator

The Antimatter Electrical Generator is designed to utilize the following principles: photons production by the stimulation of atoms with electric discharges, light flashes, or any other means; photons amplification by population inversion of excited atoms; particle-antiparticle production by the collision of photons; ion-pairs generation by the striking of high energy charged particles with atoms at rest, and subsequent generation of electron-positron avalanches within conducting materials; finally, the separation of electron-positron pairs by the crossing of strong electromagnetic forces, originating the phenomena know as Electricity.

Physical Description

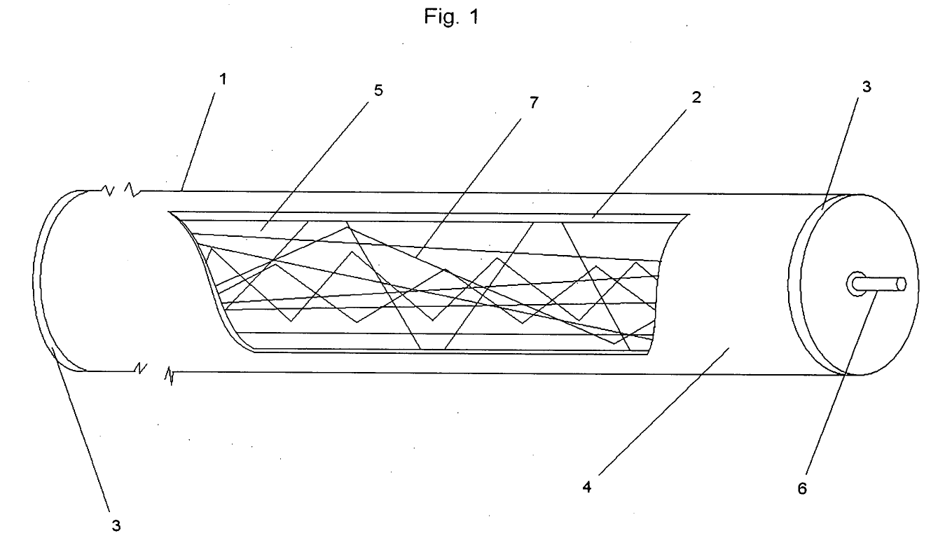

FIGS. 1, 2 and 3 refer to the basic elements of an Antimatter Electrical Generator designed for the direct production of Electric Voltages and Currents, which embodies in itself a Particle Generator, a Particle Accelerator, a Particle Collider, a Detector-Collector of matter and antimatter particles, and an Electrical Generator.

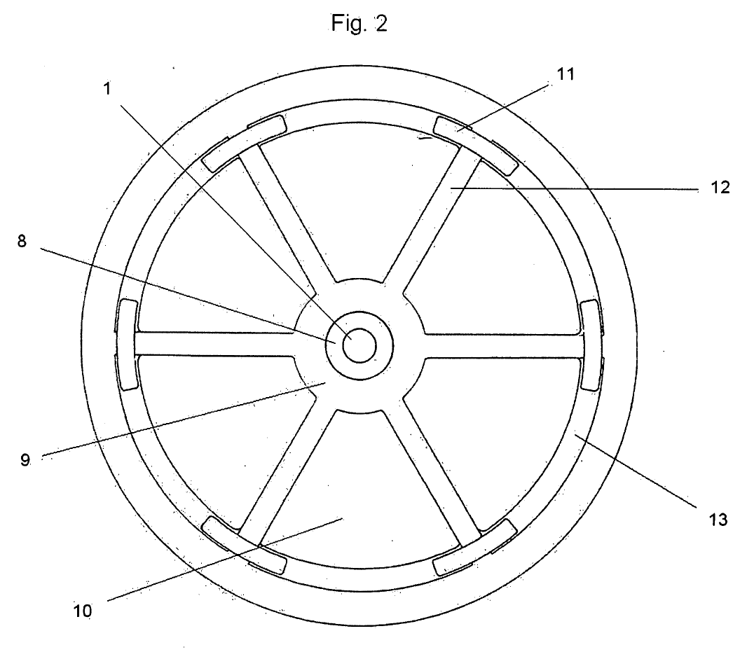

A Self-Reflective Chamber, shown in FIG. 1, positioned at the center of the generator, as shown in FIG. 2, comprising a cylinder 2, two end lids 3, one at each end of the cylinder, a pair of electrodes 6, one at each end lid and means to assemble hermetically said cylinder to said lids (not shown), being the entirety of its inner surface highly reflective to photons, conforming a self-reflecting confined space.

The cylinder must be done of non electrically conductive materials as glass, ceramics, synthetics or even of metals as far as they are properly electrically insulated. The purpose is not to interfere with high voltages or discharges needed to start the system, as will be described later on. Its inner surface must be as highly reflective to photons as possible, in its entirety. If manufactured of mirrored glass including metallic paints, the reflective plate should be properly insulated to avoid electric arcs.

The end lids 3 can be made of non electrically conductive materials having a highly reflective inner surface and an electrode 6 also of highly reflective surface to the inside (not shown) placed in such way that it will expose its inward surface to the inside of the chamber, while preserving the sealing.

Said electrodes 6 are designed to produce electrical discharges for the stimulation or pumping of said lasing medium, but said lasing medium can be stimulated by other means as internally created flashes of light, diode pumping, external sources of light transmitted by fiber cable means, or any other means.

Another embodiment is to fabricate the lids of highly reflective and electrically conductive metals or materials, so as to serve simultaneously as electrodes. Electrodes could eventually be replaced by a single Fiber Optic cable (not shown), substituting the electric discharges for flashes of appropriate frequency and wavelength light.

Lids' inner surface can be flat, concave, convex or of any other type of reflective surface, depending on the desired direction for the photon's reflection.

The Self-Reflective Chamber 1 has in its interior a lasing medium 5, either it is a solid, a liquid, a gas, a plasma, a semiconductor, or any other type of lasing medium, or any other photons' emitting system. Said Self-Reflective Chamber can be totally filled with the lasing medium, or being partially filled with said lasing medium and partially filled with light emitting gasses or materials.

While not in the scope of the present invention and for the same reason not shown, said Self-Reflective Chamber must have external means to provide the energy or the means for the excitement, stimulation or pumping of said lasing medium, comprising but not limited to: electric power; electronic controls; high voltage systems; light transmitted by fiber cable means.

A second cylindrical chamber, or Cooling Chamber 8, FIGS. 2 & 3 goes around the Self-Reflective Chamber 1, it is essentially an empty chamber, left for cooling purposes, either the coolant is air, water, or any other, and only for the case of excessive heat in the Self-Reflective Glass Chamber 1.

The whole system is incorporated in a Ferromagnetic Assembly as shown in FIGS. 2 & 3, having a Laminated Ferromagnetic Core 9 of high magnetic permeability and inductance and low inherent losses, as in high efficiency electrical generators, containing a plural number of slots 13, a plural but equal number of legs 12, both radially distributed, and having a central circular hole. The diameter of the Core 9 will depend on the distance particles and antiparticles travel through said Ferromagnetic Assembly, after the photon's collisions inside said Self-Reflective Chamber 1.

Each lamination is made of one thin single piece of high magnetic permeability and inductance and low inherent losses metal, dielectrically insulated, so that there won't be air gaps or changes on materials along the magnetic path. This will permit the creation of a very strong magnetic field with a reduced amount of electrical energy. Laminations can also be fabricated of assembling pieces, taking care not to leave air gaps in between. The number of laminations will depend on the desired length of the unit, the thickness of the lamination and it's insulation.

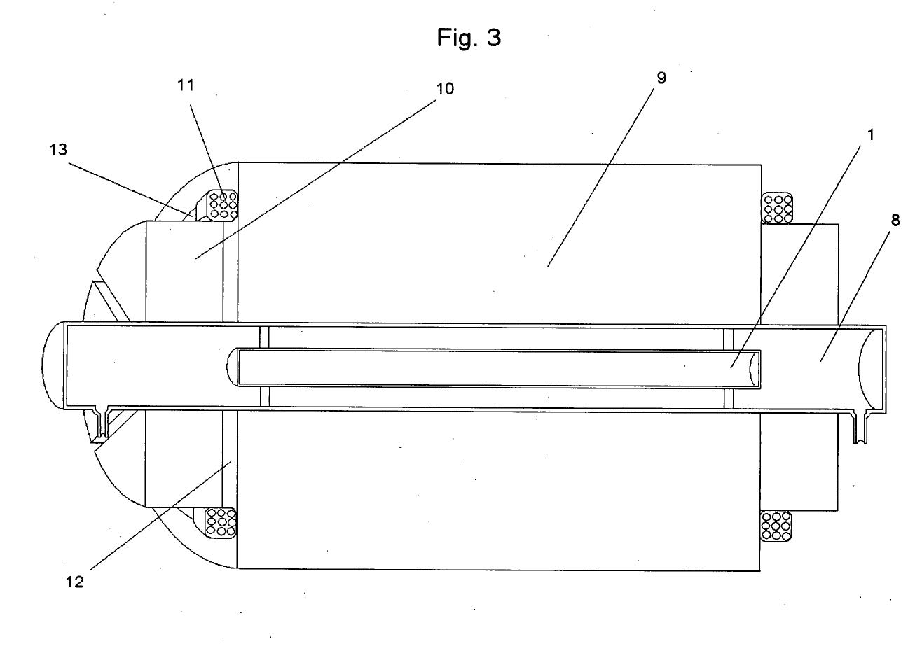

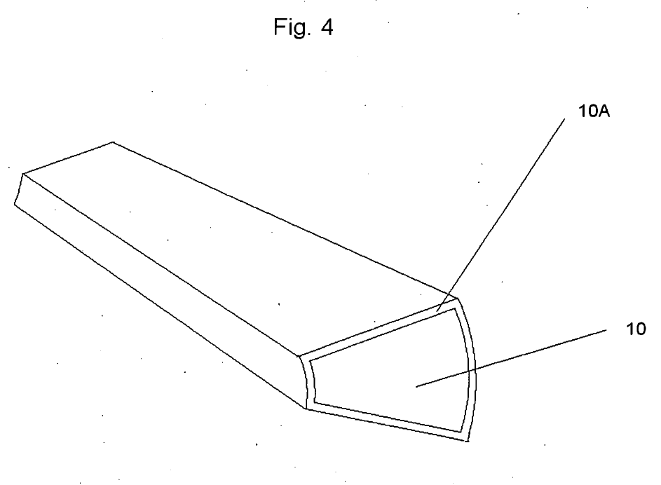

Collecting Masses 10 consist of solid pieces of: dense metals as lead, steel or copper; electromagnetic coils; or, even contained liquids, gases or plasmas, as far as the can conduct electricity efficiently. Said Collecting Masses 10 will fill most of the available space in the referred slots 13, all along the Ferromagnetic Core 9. Said Collecting Masses should be properly dielectrically insulated 10A in FIG. 4, accordingly to the high Electrical Potential to be generated. For convenience, said Collecting Masses 10 may extend outside over said Ferromagnetic Core 9, as shown in FIG. 3, to accommodate electric conducting terminals or cables (not shown in drawings). Said Collecting Masses 10 should stop most of said particles and antiparticles thoroughly, with the exception of Muons.

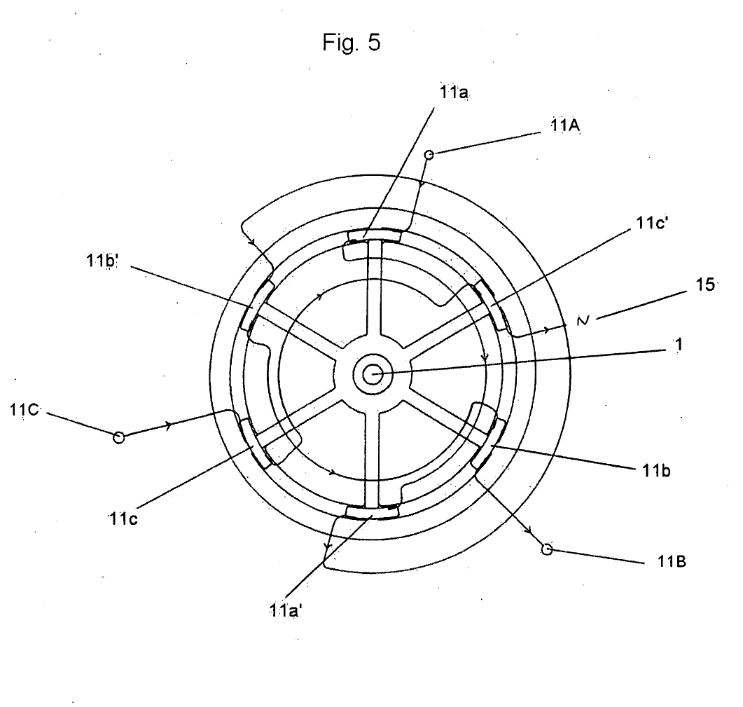

Said Electric Coils 11 are placed at the outermost end of the Ferromagnetic Core legs 12, as shown in FIGS. 2 & 5. The opposite pairs of Electromagnetic Coils 11a-11a′, 11b-11b′, 11c-11c′ are connected in series. The ending terminals are connected in Y, to form a Neutral 15, in a typical Three Phase arrangement, as shown in FIG. 5. Three Phase Voltage, spaced 120 electrical degrees, is to be applied through terminals 11A, 11B and 11C. The source of three phase voltage is not in the scope of the present invention, and for the same reason is not show in drawings.

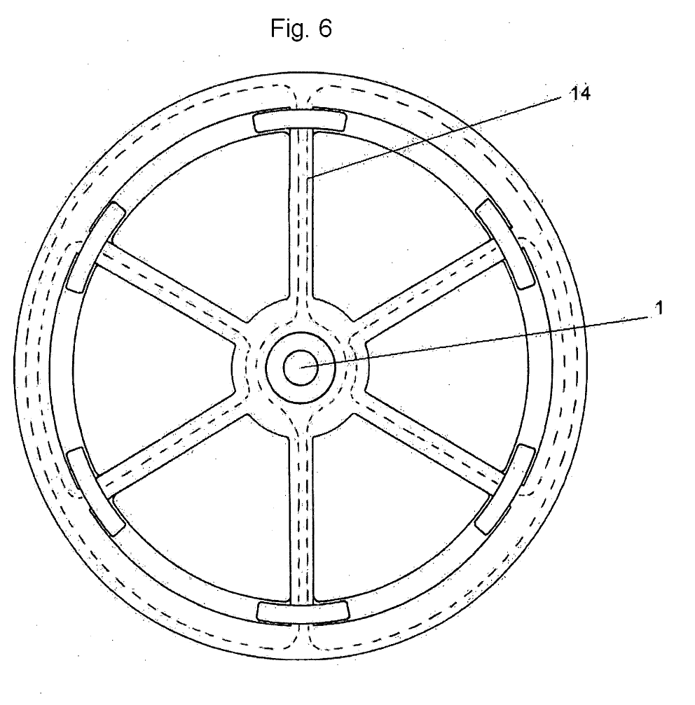

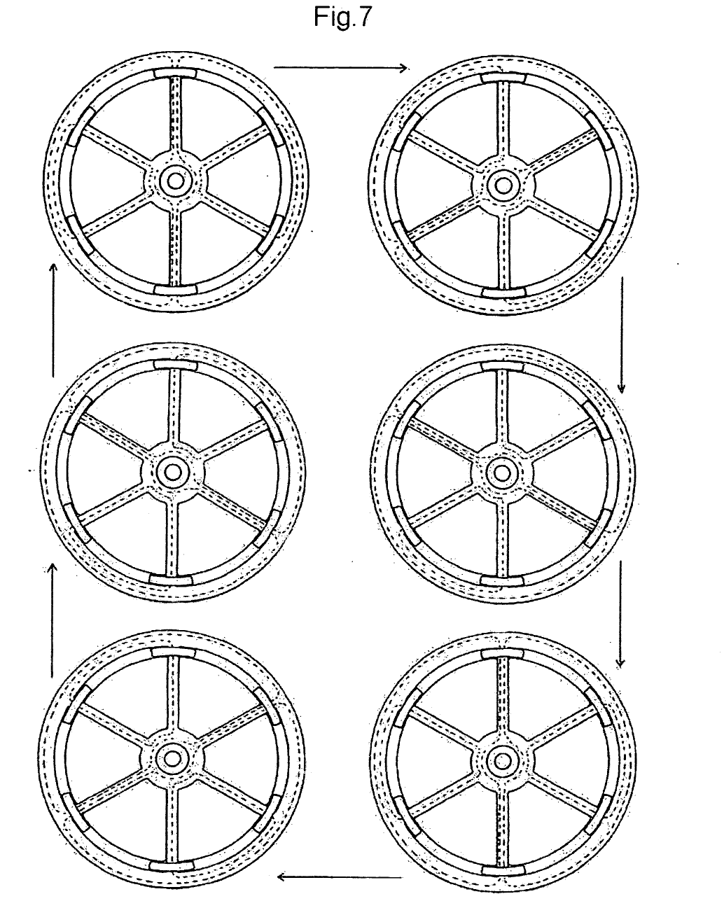

The Electromagnetic Field Pattern 14 created at a given instant by the application of an external source of Three Phase Voltage to terminals 11A, 11B and 11C (FIG. 5), is shown in FIG. 6. Since there are not air gaps or change in materials, we can create a very strong electromagnetic field over 2 Teslas, and under superconducting conditions, up to 10 Teslas. The application of the Three Phase Voltages spaced 120° electrical degrees, will create a strong Rotational Magnetic Field within the Core 9, as shown in FIG. 7.

Phenomena Description

When the Self-Reflective Chamber's 1 lasing medium 5 is excited or “pumped” by the application of high voltages to the pair of electrodes 6, as to create an electric arc through the lasing medium 5, or by the application of light flashes, in a similar way as Lasers and/or Fluorescent bulb lights get excited, it's atoms will start releasing photons 7 which will travel in all directions at or near the speed of light, within the Self-Reflective Chamber 1.

As all surfaces around the lasing medium are highly reflective surfaces or mirrors, the photons thus formed will be continually and indefinitely reflected from the inner surface, at or near the speed of light. This photons, in turn, will excite more atoms, and more photons will be released. As photons will always be reflected from the inner surface they can not escape said Self-Reflective Chamber 1. As more photons form, and more atoms get excited just to release more photons, with no stop to the process, the photon density will start to mount up at higher and higher rates.

At certain point the photon density within said Self-Reflective Chamber 1 will be so high that photons traveling at or near the speed of light in all directions will start to collide with other photons crossing in their paths; but, still, the photon density will continue to increase until the number of collisions and the consequent disintegration of photons at a given instant will enter in equilibrium with the production of new photons.

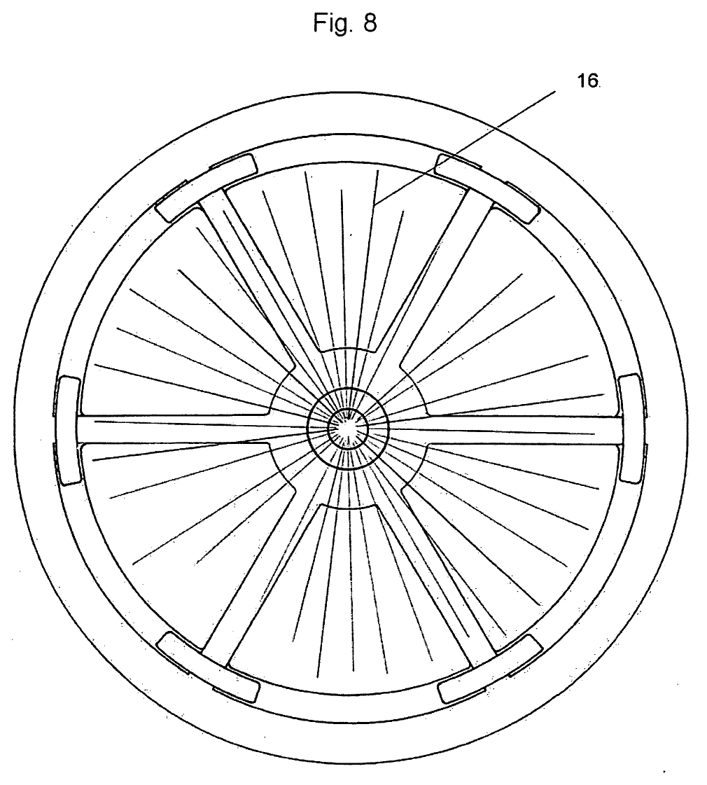

Each pair of collided photons will disintegrate into beams of particles and antiparticles of the first, which will this time pass across the cylinder walls in uncertain directions into the laminated Ferromagnetic Assembly and the Collecting Masses 10, setting free a formidable amount of energy, that could be in the order of 183 to 209 GeV per collision as mentioned before. FIG. 8. shows a hypothetical instant within said Ferromagnetic Assembly at work.

Quarks and antiquarks, and their correspondent beams of particles and antiparticles, after abandoning said Self-Reflective Chamber 1 through its walls, will penetrate into the Collecting Masses 10, colliding with atoms at rest of masses' component matter all along their mean paths.

The striking of said charged particles and antiparticles with atoms at rest within said Collecting Masses will cause the ionization of said atoms and the production of electron-ion pairs, this is, electrons and a positrons. The pairs of electrons created will continue to drift, creating more electron pairs and so on, forming, under appropriate circumstances, what is known as an avalanche multiplication, as described above in Multiwire Proportional Chambers in paragraph [0012].

At the same time, the charged particle or antiparticle will continue to impact more and more atoms at rest, until it losses all its energy, causing a great number of avalanches. If nothing separates the ion pairs by force, they will reunite and annihilate each other soon after the crossing of the charged particle, and matter atoms will be back at rest.

Now, in the same way as the crossing of an electromagnetic field through a conductor will cause the separation of electron pairs in opposite directions causing the phenomena known as Electricity, the above referred Rotational Electromagnetic Field 14 will also cause the separation of the ion pairs created by the passing of charged particles through the component matter of the Collecting Masses 10.

The Collecting Masses 10, for being a conductor under a moving magnetic field, will act as a secondary coil to the opposite pairs of Electromagnetic Coils 11a-11a′, 11b-11b′, 11c-11c′, for which the Collecting Chamber masses 10 will carry a voltage of their own, which will be proportional to the inducting voltage and the turns ratio between the primary and the “secondary”.

The crossing of the Rotational Electromagnetic Field 14 will separate as well the electron pairs created by the induction of voltage and the electron pairs and their avalanches created by the collision of charged particles with atoms at rest, for which the Electric Potential or Voltage at said Collecting Masses will be significatively augmented, proportionally to the additional number of electron pairs present at a given instant.

The flow of electrons and positrons along the Collecting Chamber masses 10 in opposite directions will manifest as Electric Alternating Currents, since the rotation of the magnetic field will change polarity every half cycle, and so the direction in which the electrons and positrons will flow.

Said charged particles will be crossing also the laminated Ferromagnetic Core metal, outside the Collecting Masses, and will also ionize and create electron pairs in its atoms at rest, but since those electrons have no where to go, due to the thin lamination and the insulation of said laminations, the pairs will neutralize them selves soon after the passing of the charged particle and its atoms will be back at rest.

Said charged particles, once they have lost all their energy in the process, will stop and probably react with the matter of the Collecting Masses 10 or the Core's matter, and nullify themselves.

The induction itself can only produce a similar amount of power as we have put in to create the Rotational Electromagnetic Field 14, but the additional electron pairs and their avalanches that come from the disintegration of photons within the Self-Reflective Chamber 1 and their collision with atoms at rest in the Collecting Chamber masses 10, will create a much higher power out than we had put in, without violating any Physics law.

Now, how highly will the photon density increase before the number of photon's collisions enter in equilibrium with photon production at a given instant, is, off course, unknown, but this equilibrium point will perfectly determine the Nominal Electrical Potential of the generator for uninterrupted usage purposes.

The total amount of energy a device like this might release in its life time, may be given by E=mc², if the formula is correct or applicable, where m would be the mass of the lasing media within the Self-Reflective Chamber 1.

This would imply that photons produced by the stimulation of matter are actually the conversion of such matter into pure energy. If it occurs that at some point the mass of the lasing media totally disintegrates into energy, the simple replacement of said matter will reactivate the process and the electric generation.

Part B—Antimatter Fuel Systems

Principles for the Antimatter Fuel Generator.

The Antimatter Fuel Generator is designed to utilize the following principles: photons production by the stimulation of atoms with electric discharges, light flashes, or any other means; photons amplification by population inversion of excited atoms; particle-antiparticle production by the collision of photons; and the separation of charged particles and antiparticles by charge by the action of a strong Monopolar Rotational Magnetic Field.

Physical Description

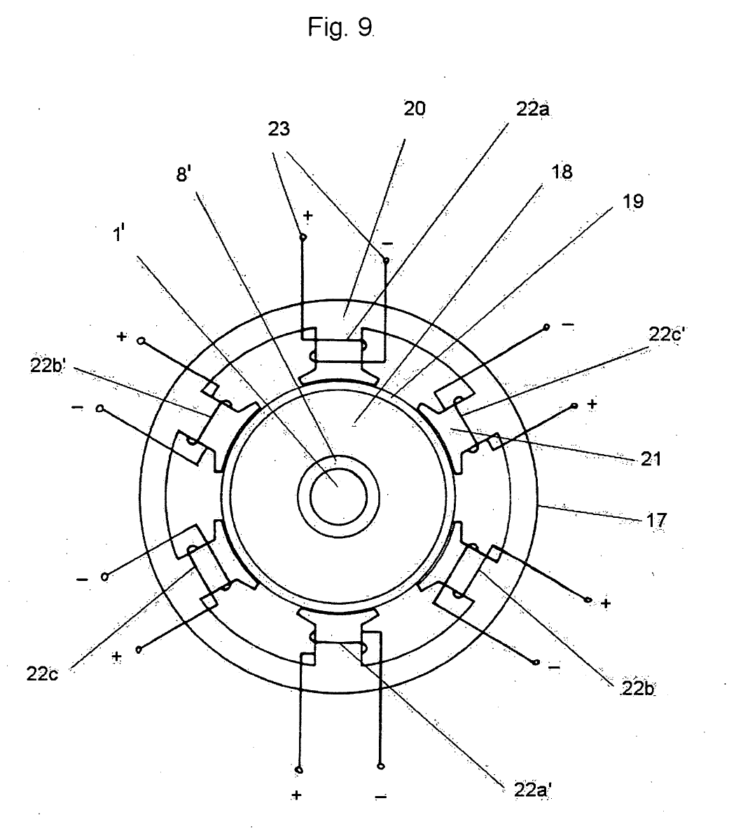

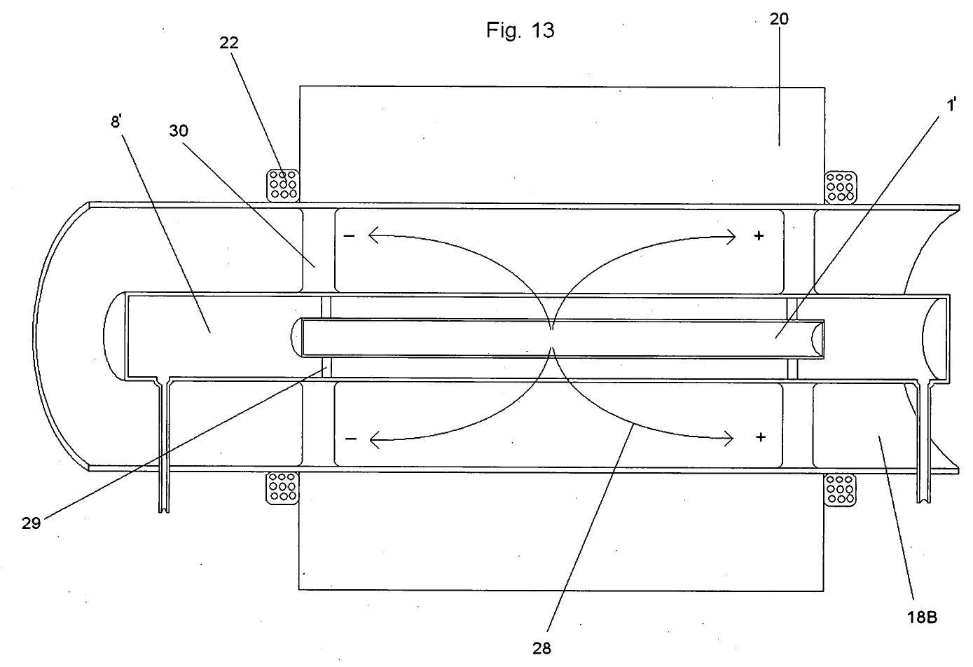

FIGS. 9 and 13 refer to the basic elements of an Antimatter Fuel Generator designed for the direct production of Antimatter Fuel, which embodies in itself a Particle Generator, a Particle Accelerator, a Particle Collider and a Particle-Antiparticle Separator.

The whole system is incorporated in a second Ferromagnetic Assembly as shown in FIGS. 9 and 13, having a laminated Ferromagnetic Core 20 of high magnetic permeability and inductance and low inherent losses, containing a plural number of salient poles radially distributed, and having a central circular hole. The outer an the inner diameters of said Ferromagnetic Core 20, will depend on the distance particles and antiparticles travel through said second Ferromagnetic Assembly, in the same way as in prior embodiment.

Each lamination is made of one thin single piece of high magnetic permeability and inductance and low inherent losses metal, dielectrically insulated, so that there won't be air gaps or changes on materials along the magnetic path. This will permit the creation of a very strong magnetic field with a reduced amount of electrical energy. Laminations can also be fabricated of assembling pieces, taking care not to leave air gaps in between. The number of laminations will depend on the desired length of the unit, the thickness of the lamination and it's insulation.

FIGS. 9 and 13 shows the embodiment of an Antimatter Fuel Generator 17 where the same Self-Reflective Chamber 1′ and Cooling Chamber 8′ described above, are placed at the center of the generator, supported by vertical columns 29 of neutral materials as glass or ceramic.

Between the Cooling Chamber 8′ an the Ferromagnetic Core 20 goes a Vacuum Collecting Chamber 18 which is a pipe or tube built preferably of a non electrically and magnetically conductive material as glass or ceramic 19. Said Vacuum Collecting Chamber 8′ is placed all along the Antimatter Fuel Generator 17 as shown in FIG. 13, extending to the exterior of the generator and connecting with an external vacuum and electromagnetic system for the transportation and management of said particles and antiparticles. The external system, which may be a conventional antiparticles transportation system, is not under the scope of the present set of inventions and not shown in drawings.

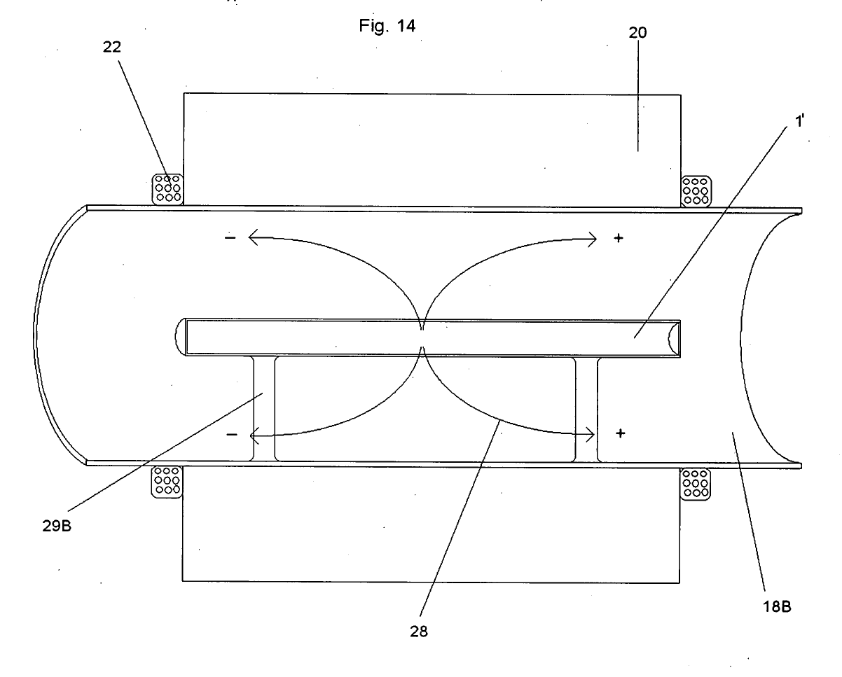

A third embodiment shown in FIG. 14 shows an Antimatter Fuel Generator not having a Cooling Chamber to avoid the loss of antimatter particles while passing through the cooling substances ant the Cooling Chamber itself.

Plural number of pairs of coils 22a-22a′, 22b-22b′ and 22c-22c′, are placed each pair in opposed poles, as shown in FIG. 9, having each of the coils two terminals 23, one for positive direct current voltage and one for negative direct current voltage, as shown.

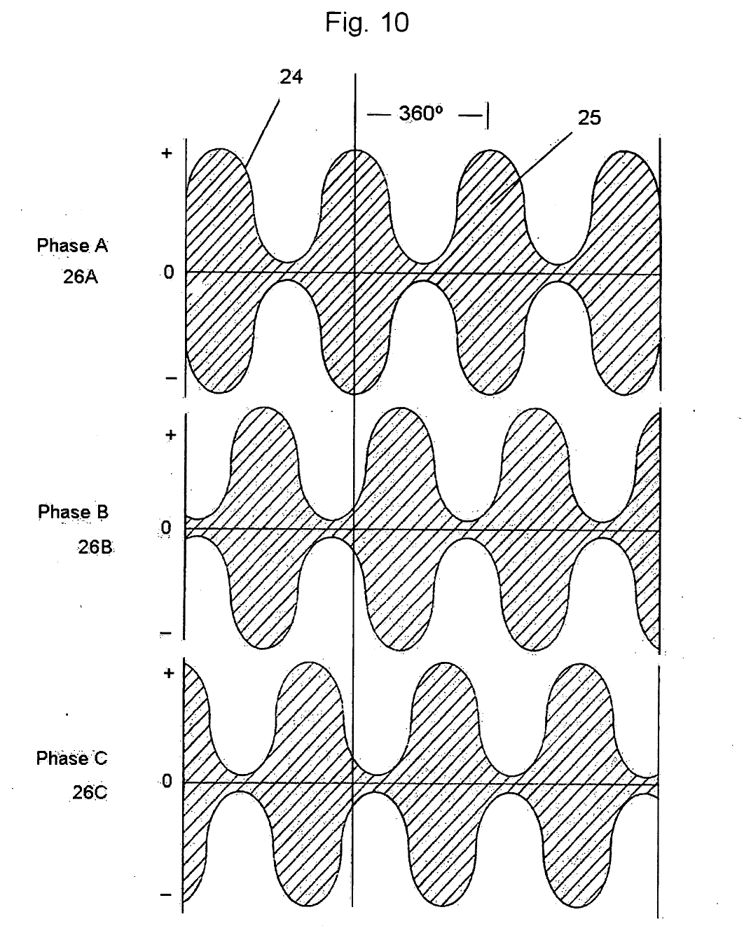

A complementary invention necessary for the operation of the Antimatter Fuel Generator is a Three Phase Direct Current Monopolar System, shown in FIGS. 9 and 10, designed to produce three pairs of exactly opposed sinusoidal wave shaped direct currents 24, spaced 120 electrical degrees among pairs. The first pair of opposed sinusoidal wave shaped direct currents is shown as Phase A 26A, the second pair is shown as Phase B 26B y the third pair is shown as Phase C 26C in FIG. 10. The power pattern 25 produced when such Three Phase Direct Current voltages are applied to the terminals 23 of coils 22a-22a′, 22b-22b′ and 22c-22c′ is shown in FIG. 10.

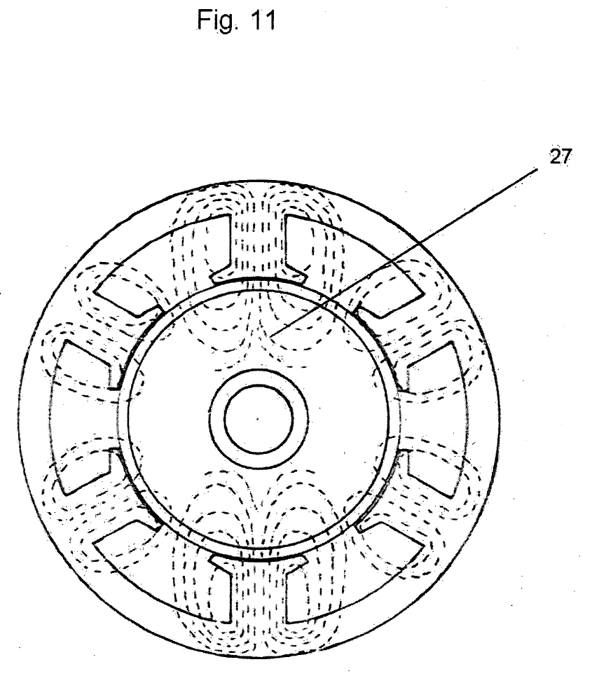

FIG. 11 shows the electromagnetic pattern formed at a given instant when said Three Phase Direct Current Voltages are applied to terminals 23 of coils 22a-22a′, 22b-22b′ and 22c-22c′ in the way indicated above and in FIGS. 9 and 10. All the salient poles will have the same magnetic polarity to the inside, unvariably, creating thus a Rotational Monopolar Electromagnetic Field 27 to the inside of said Ferromagnetic Assembly, while the opposite pole will always go outwards toward the common ring of said Ferromagnetic Core.

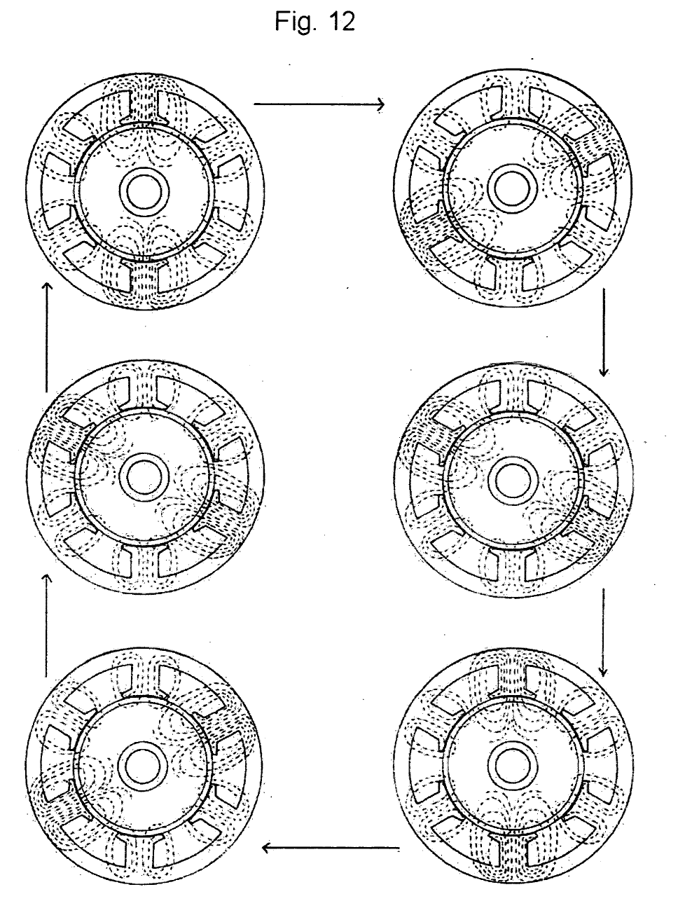

FIG. 12 shows the inwards Rotational Monopolar Electromagnetic Field pattern developed when the Three Phase Direct Currents described above are applied to terminals 23 of coils 22a-22a′, 22b-22b′ and 22c-22c′ within a time period.

The external source and methods for the generation and application of these sinusoidal and opposed direct currents are not in the scope of the present invention. For the same reason said external source is not shown in drawings.

FIGS. 13 and 14 is showing in a longitudinal cut, the hypothetical separation and the ejection of particles and antiparticles 28 in opposite directions by the action of the Rotational Monopolar Electromagnetic Field.

Phenomena Description

Particles and antiparticles traveling outside of said Self-Reflective Chamber 1′ could be separated by today's conventional means, this is directing and managing them with the use of magnetic and electric fields, as in many particle accelerators in use today. But, in order to simplify the separation and extraction of particles and antiparticles from the generator in a secure way, a design involving the use of a Three Phase Direct Current Monopolar System is presented here.

Antimatter particles must be handled in vacuum and shielded with magnetic and electric fields to avoid their reaction with normal matter or their antiparticles. For this reason a Vacuum Collecting Chamber 18 is necessary. Now, since the Vacuum Collecting Chamber 18 will be exposed to a rotational electromagnetic field, it may produce parasite currents if made of a conducting material, for which it would be more appropriate to build it of a non conducting material like glass or ceramics.

The rotation of a inward monopolar magnetic field will expel at high speed, probably near the speed of light, in opposite directions, the charged particles and antiparticles created inside said Self-Reflective Chamber 1, in a similar way as ion pairs are separated and expelled in opposite directions by the relative movement of a magnetic field as described above for the Antimatter Electrical Generator. But this time, as only one pole is constantly passing through, the direction at which particles and antiparticles will be deviated will remain constant.

Some of the particles and antiparticles coming from said Self-Reflective Chamber 1 may be lost by entering in contact with the materials of the referred columns supporting said Self-Reflective Chamber 1 and said Cooling Chamber or their walls, the cooling element, the Vacuum Chamber walls or by reaching the referred Ferromagnetic Core. For this reason, the preferred embodiment should have as few elements in their paths as possible, as the one presented in FIG. 14, not having a Cooling Chamber.

An alternating current rotational field could also separate particles and antiparticles in opposite directions, but the directions will change as fast as the polarity changes, sending both, matter and antimatter, in the same direction within very short intervals creating hard to handle difficulties and risks of monumental explosions, due to the possibility of a very high number of particles and antiparticles very close to each other, separated only by electromagnetic fields.

Particles and antiparticles obtained by photon's collisions inside a very simple chamber as the one described in the present set of complementary inventions, could be the practical solution for the propulsion of spacecraft, among many other possible uses. The power potential of the recombination of particles and antiparticles obtained from photon's collisions is still uncertain, but it might be apparently very high.

Instead of having enormous antimatter production plants on earth, huge storing devices or facilities and a whole antimatter fuel transportation infrastructure, Antimatter Fuel could be produced on demand, on the site, in practically any amount.

I claim:

1.-20. (canceled)

21. means for the amplification, concentration and collision of photons for the generation of energy,

22. means of claim 21 comprising the generation, amplification, concentration and collision of photons within a single confined space,

23. said single confined space of claim 22 having walls highly reflective to said photons in its entire inner surface, conforming a self-reflective chamber, as shown in FIG. 1,

24. said self-reflective chamber of claim 23 having a cylindrical shape, comprising:
a. a cylinder having a wall in its interior which is highly reflective to said photons,
b. lids at both ends of said cylinder which are also highly reflective to said photons at their inner surface, having:
i. a flat,
ii. concave,
iii. convex, or
iv. any other type of reflective surface to the interior of said self-reflective chamber,
v. electrical connections to the exterior,
c. means to assemble said cylinder to said lids (not shown in drawings),
d. a plural number of electrodes to the interior of said self-reflective chamber,

25. said cylinder of claim 24 being made of non electrically conductive material, comprising:
a. glass,
b. ceramics,
c. synthetic materials,
d. electrically insulated conductive materials,

26. said lids of claim 24 being made of highly reflective and electrically conductive metal or material so as to serve also as electrodes,

27. said self-reflective chamber of claim 23 having in its interior a lasing medium, comprising:
a. a solid lasing medium,
b. a liquid lasing medium,
c. a gaseous lasing medium,
d. a plasma lasing medium,

28. said self-reflective chamber of claim 23 being either totally filled with said lasing medium or partially filled with said lasing medium,

29. said self-reflective chamber of claim 23 having means for the excitement, stimulation or pumping of said lasing medium, comprising:
a. electrical discharges,
b. flashes of light,
c. diode pumping,
d. light transmitted by fiber cable or other means,

30. said self-reflective chamber of claim 23 having the means for the generation, amplification, concentration and collision of said photons and their disintegration into subatomic particles and antiparticles, comprising:
a. means for the production of photons by said stimulation of atoms,
b. means for the population inversion of excited atoms for the creation of said amplification of photons,
c. means for the continuous reflection of photons to the inside of the chamber, causing increasingly concentration of photons,
d. means for the continually increasing collision of photons and their disintegration into subatomic particles and antiparticles,
e. providing the means for subatomic particles and antiparticles to abandon said self-reflective chamber through its walls,
whereby, once the self-reflecting chamber's lasing medium is pumped or stimulated, it will trigger or unleash a continuously increasing amplification of said photons, causing a continuously increasing concentration of said photons traveling at or near the speed of light in every direction within said self-reflective chamber, continually and indefinitely bouncing back from said reflective walls within said self reflective chamber,
whereby said photons will increasingly collide with other photons, for as far as an equilibrium point is reached between the new photons forming by said amplification and the ones colliding and annihilating or disintegrating,
whereby, each pair of collided photons will disintegrate to form jets of high energy subatomic charged particles and antiparticles, matter and antimatter of each other, which will this time pass across the self-reflective chamber's walls,

31. means of claim 21 having a ferromagnetic assembly as shown in FIGS. 2 and 3, comprising:
a. a laminated cylindrical ferromagnetic core, comprising:
i. a common ring,
ii. a plural number of slots radially distributed,
iii. a plural number of legs radially distributed,
iv. a central circular hole,
b. multiple number of dielectrically insulated laminations stacked together to form said ferromagnetic core, wherein,
i. said laminations being made of thin metal sheet,
ii. said laminations having high magnetic permeability and inductance, and low inherent losses,
c. plural number of electromagnetic coils radially distributed, wherein,
i. said electromagnetic coils being placed embracing the foremost end of each said legs,
ii. said electromagnetic coils being interconnected in a three phase arrangement, as shown in FIG. 5,
d. plural number of collecting masses, one or more per each of said slots, wherein,
i. said collecting masses being dielectrically insulated from the rest of said ferromagnetic assembly,
ii. said collecting masses being made of electrically conductive materials, comprising:
a) solid metals,
b) electromagnetic coils,
c) contained liquids
d) contained gasses,
e) contained plasma,
e. a said self-reflective chamber being placed at the center of said ferromagnetic core,
f. a cooling chamber as shown in FIG. 3 under numeral 8, wherein,
i. a said cooling chamber encases said self-reflective chamber,
ii. enough space being left between said cooling chamber and said self-reflective chamber as to permit the circulation of a coolant substance,

32. means of claim 21 providing the crossing of charged particles and antiparticles through said collecting masses for the creation of ion pairs and their separation into electrons and positrons by the action of a strong rotational electromagnetic field, comprising:
a. means for the creation of charged particles and antiparticles within said self-reflective chamber,
b. means for the displacement of said charged particles and antiparticles into said collecting masses,
c. means for the creation of ion pairs at the passing of said charged particles and antiparticles through the atoms of said collecting masses,
d. means for the creation of avalanches of said ion pairs within said collecting masses,
e. means for the separation of ion pairs for the creation of electric power, by the action of rotational electromagnetic fields,

33. collecting masses of claim 31 being interconnected in a three phase arrangement or in any other arrangement, including working each one independently, wherein,
a. said collecting masses having electric terminals for the extraction of electric currents (not shown in drawings),
b. each of the collecting masses having an electrical potential or voltage of its own,
c. the electrical potential of independent collecting masses being able to be added by connecting them in series,
d. the electrical currents of said independent collecting masses being able to be added by connecting them in parallel,
whereby, simultaneously to the pumping or stimulation of said lasing medium within said self-reflective chamber, a three-phase alternating current voltage is applied to said electromagnetic coils (FIG. 5), causing the creation of a strong rotational electromagnetic field within said ferromagnetic assembly (FIGS. 6 and 7),
whereby, said subatomic charged particles and antiparticles passing across said self-reflective chamber's walls will penetrate said collecting masses striking at their crossing the collecting masses' atoms all along their mean paths, causing the ionization of said collecting masses' atoms and the consequent production of ion pairs, this is electrons and positrons,
whereby, said electrons and positrons will drift on their own creating more and more electron pairs and so on, forming what is known as an avalanche multiplication,
whereby, at the same time, each charged particle will continue to impact more atoms at rest until it losses all its energy, but causing a great number of avalanches within said collecting masses,
whereby, said strong rotational electromagnetic field will then cause the separation of said electron pairs by charge, in opposite directions, in the same way as the crossing of an electromagnetic field through a conductor will cause the separation of electron pairs in opposite directions causing the phenomena known as electricity,
whereby said collecting masses, having an induced voltage of their own for being under an electromagnetically rotational field, will significantly augment their voltage proportionally to the additional number of electron pairs present at a given instant,
whereby a great number of said photons collisions within said self-reflective chamber will result in an exponential augmentation of the nominal voltage at said collecting masses, converting the system in an antimatter electrical generator, in which the equilibrium point between the creation of the new photons and their disintegration by said collisions will perfectly determine the nominal electrical potential of the generator for uninterrupted usage purposes,

34. a second embodiment with means for the conversion of said subatomic charged particles and antiparticles directly into antimatter fuel,

35. means of claim 34 having a second ferromagnetic assembly as shown in FIGS. 9 and 13, comprising:
a. a second laminated cylindrical ferromagnetic core, comprising:
i. a common ring,
ii. plural number of salient poles radially distributed,
iii. plural number of legs radially distributed,
iv. a central circular hole,
b. a plural number of electromagnetic coils as shown in FIG. 9, wherein,
i. said coils are placed by pairs in opposite poles,
ii. each of said coils having two terminals, one for positive direct current voltage and one for negative direct current voltage, as shown in FIG. 9,
c. a vacuum collecting chamber consisting of a tube or pipe passing along said central circular hole of said second ferromagnetic core, made preferably but no necessarily of non electrically and non magnetically conductive materials, comprising:
i. glass,
ii. ceramic materials,
iii. synthetic materials,
d. a self-reflective chamber, similarly as in preceding embodiment, placed at the center of said second ferromagnetic core as shown in FIGS. 9, 13 and 14,
e. an optional cooling chamber as shown in FIG. 13, encasing, similarly as in preceding embodiment, said self-reflective chamber, having enough space between both to circulate a coolant,

36. means of claim 34 having electromagnetic means, as shown in FIGS. 9 to 12, for the creation of an inward rotational monopolar electromagnetic field, comprising:
a. three pairs of electromagnetic coils placed on opposite salient poles,
b. three pairs of opposed sinusoidal wave shaped direct currents,
c. said pairs of opposed sinusoidal wave shaped direct currents being displaced 120 electrical degrees among pairs,
d. an external source of opposed sinusoidal wave shaped direct currents,
whereby, when such three phased pairs of said sinusoidal wave shaped direct currents are applied to the terminals of said electromagnetic coils as shown in FIGS. 9 and 10, they will create a rotational monopolar electromagnetic field toward the center of said second ferromagnetic assembly, while the opposite pole will always go outwards toward said common ring of said ferromagnetic core,
whereby, when said particles and antiparticles produced from the collision of said photons inside said self-reflective chamber abandon said self-reflective chamber through its walls, they will be separated by charge and expelled in invariable opposed directions along said vacuum collecting chamber by the action of said inward rotational monopolar electromagnetic field,
whereby, once said charged particles and antiparticles are expelled from said ferromagnetic assembly separately, they can be handled by already conventional means not in the scope of the present patent application, to be conducted, stored or directly used as antimatter fuel in propulsion systems or any other systems,

37. method for producing, amplifying, concentrating and colliding said photons for the direct generation of electricity and antimatter fuel,

38. method of claim 37 containing a method for producing, amplifying, concentrating and colliding said photons within said self-reflective chamber containing a said lasing medium, comprising:
a. stimulating or pumping said lasing medium contained within said self-reflective chamber by any of different methods, comprising:
i. electrical discharges,
ii. flashes of light,
iii. diode pumping,
iv. light transmitted by fiber cables, or by any other means,
b. causing a continuously increasing amplification of said photons by the continuous reflection of every new photons created over said lasing medium,
c. causing the concentration of said photons by blocking their escape from said self-reflective chamber while their number continue to increase exponentially,
d. causing forced collisions of said photons traveling in all directions at or near the speed of light by the exponential and continuous augmentation of the photon density or concentration to the point of saturation of the available space,
e. causing the production of jets of subatomic charged particles and antiparticles, matter and antimatter of each other, by said collision of photons within said self-reflective chamber,
f. allowing the crossing of said jets of subatomic charged particles and antiparticles through the walls of said self-reflective chamber,

39. method of claim 37 including a method for generating electricity by using the displacement of said subatomic charged particles and antiparticles through a ferromagnetic assembly as the one shown in FIGS. 2, 3, 5,6, 7 and 8, comprising:
a. building said ferromagnetic assembly as illustrated in referred FIGS. 2, 3, 5, 6, 7 and 8,
b. building said collecting masses occupying most of the probable surrounding volume for the mean paths of said subatomic charged particles and antiparticles, wherein:
i. said collecting masses being dielectrically insulated from the rest of said ferromagnetic assembly,
ii. said collecting masses being made of electrically conductive materials, comprising:
a) solid metals
b) electromagnetic coils,
c) contained liquids,
d) contained gasses,
e) contained plasma,
c. causing the referred subatomic charged particles and antiparticles to cross through the atoms at rest of said collecting masses, by placing said collecting masses within the most probable mean paths of said charged subatomic charged particles and antiparticles, as shown in FIG. 8,
d. causing the generation of ion pairs, electrons and positrons, by allowing the crossing of said subatomic charged particles and antiparticles through said atoms at rest within said collecting masses,
e. causing the generation of avalanches of said electrons and positrons by allowing the crossing of said subatomic charged particles and antiparticles through said atoms at rest within said collecting masses,
f. causing, simultaneously with the generation of said ion pairs and said avalanches of the same described in prior numerals c, d and e, the creation of an electromagnetically rotational field within said ferromagnetic assembly by applying three-phase current voltages to the three phase system shown in FIG. 5,
g. causing the induction of electric potential or voltage on said collecting masses, by the action of said electromagnetically rotational field,
h. causing the separation and displacement of the supplementary electrons and positrons created by the crossing of said subatomic charged particles and antiparticles in alternated opposite directions by the action of said electromagnetically rotational field,
i. causing the augmentation of said of said electric potential or voltage on said collecting masses by allowing the creation of supplementary electrons and positrons created by the crossing of said subatomic charged particles and antiparticles through the atoms at rest of said collecting masses,
j. causing thus the transformation of the energy of said subatomic charged particles and antiparticles into electricity,
whereby the new electric potential of said collecting masses can be used directly as electric power or electricity,

40. method of claim 37 having an alternative method for the conversion of said subatomic charged particles and antiparticles directly into antimatter fuel, comprising:
a. building a second ferromagnetic assembly as shown in FIGS. 9, 13 and 14,
b. placing the same said self-reflective chamber of first embodiment at the center of said second ferromagnetic assembly, as shown in FIGS. 9, 13 and 14,
c. building said vacuum collecting chamber occupying most of the probable surrounding volume for the mean paths of said subatomic charged particles and antiparticles,
d. creating an inwards monopolar rotational electromagnetic field within said ferromagnetic assembly by applying said three phased sinusoidal wave shaped direct currents to terminals of 22a-22a′, 22b-22b′, and 22c-22c′, as shown in FIGS. 9 and 10,
e. allowing the entering of said subatomic charged particles and antiparticles into said vacuum collecting chamber by placing said vacuum collecting chamber within the most probable mean paths of said subatomic charged particles and antiparticles,
f. causing the separation of said subatomic charged particles and antiparticles by their type of charge in constantly opposite directions by the influence of said inwards rotational monopolar electromagnetic field,
whereby, having said subatomic charged particles and antiparticles separated by charge, they can be managed or stored by known means, or directly utilized as antimatter fuel.
